(19) United States
(12) Patent Application Publication
(10) Pub. No.: US 2026/0179392 A1
(43) Pub. Date: Jun. 25, 2026

(54) MONITORING SYSTEM, MONITORING METHOD, AND NON-TRANSITORY COMPUTER READABLE MEDIUM

(71) Applicant: TOYOTA JIDOSHA KABUSHIKI KAISHA, Toyota-shi (JP)

(72) Inventor: Masayuki YAMAZAKI, Yokohama-shi (JP)

(73) Assignee: TOYOTA JIDOSHA KABUSHIKI KAISHA, Toyota-shi (JP)

(21) Appl. No.: 19/425,180

(22) Filed: Dec. 18, 2025

(30) Foreign Application Priority Data
Dec. 19, 2024 (JP) 2024-224439

(51) Int. Cl. G06V 20/59; G06V 10/77

(52) U.S. Cl. CPC G06V 20/59; G06V 10/7715

(57) ABSTRACT

A monitoring system for monitoring the interior of a vehicle using an imager extracts, from a second image captured at a second time inside the vehicle, a partial image including a difference region in a difference image between a first image captured at a first time inside the vehicle and the second image, acquires a first output result regarding an item included in the second image by inputting, into a first trained model, the partial image and a first prompt inquiring as to an item included in the partial image, and outputs a second output result regarding the correctness of the first output result by inputting, into a second trained model, the second image and a second prompt inquiring as to whether the item indicated by the first output result is included in the second image.

### CROSS-REFERENCE TO RELATED APPLICATION

This application claims priority to Japanese Patent Application No. 2024-224439 filed on Dec. 19, 2024, the entire contents of which are incorporated herein by reference.

### TECHNICAL FIELD

The present disclosure relates to a monitoring system, a monitoring method, and a program.

### BACKGROUND

Patent Literature (PTL) 1 describes generating a difference image between an image captured before a user boards and an image captured after the user alights, and identifying the name of an item left behind in the vehicle after the user alights, by performing pattern matching on that difference image.

### CITATION LIST

### Patent Literature

PTL 1: JP 2012-123491 A

### SUMMARY

Conventional configurations for identifying objects in vehicles may have difficulties in identifying items due to the presence of sunlight, the angles and color of the left items, and other factors. Thus, the conventional configurations have room for improvement in the accuracy of identifying items in vehicles.

It would be helpful to enable the identification of items in vehicles with higher accuracy.

A monitoring system according to an embodiment of the present disclosure is a monitoring system for monitoring the interior of a vehicle using an imager, the monitoring system configured to:
extract, from a second image captured at a second time inside the vehicle, a partial image including a difference region with a significant difference with a certain extent recognized in a difference image indicating the difference between a first image captured at a first time inside the vehicle and the second image;
acquire a first output result regarding an item included in the second image by inputting, into a first trained model, the partial image and a first prompt inquiring as to an item included in the partial image, the first trained model having been pre-trained, when at least an image and a first prompt are input, to output the item name of an item captured in the image; and
output a second output result regarding the correctness of the first output result by inputting, into a second trained model, the second image and a second prompt inquiring as to whether the item indicated by the first output result is included in the second image, the second trained model having been pre-trained, when at least an image and a second prompt including an item name are input, to output whether an item specified by the item name is captured in the image.

A monitoring system according to an embodiment of the present disclosure is a monitoring system for monitoring the interior of a vehicle using an imager, the monitoring system configured to:
extract, from a second image captured at a second time inside the vehicle, a partial image including a difference region in a difference image between a first image captured at a first time inside the vehicle and the second image;
acquire a first output result regarding an item included in the second image by inputting, into a first trained model, the partial image and a first prompt inquiring as to an item included in the partial image; and
output a second output result regarding the correctness of the first output result by inputting, into a second trained model, the second image and a second prompt inquiring as to whether the item indicated by the first output result is included in the second image.

A monitoring method according to an embodiment of the present disclosure is a monitoring method performed by a monitoring system for monitoring the interior of a vehicle using an imager, the monitoring method including:
extracting, from a second image captured at a second time inside the vehicle, a partial image including a difference region in a difference image between a first image captured at a first time inside the vehicle and the second image;
acquiring a first output result regarding an item included in the second image by inputting, into a first trained model, the partial image and a first prompt inquiring as to an item included in the partial image; and
outputting a second output result regarding the correctness of the first output result by inputting, into a second trained model, the second image and a second prompt inquiring as to whether the item indicated by the first output result is included in the second image.

A program according to an embodiment of the present disclosure is a program for controlling a monitoring system for monitoring the interior of a vehicle, the program configured to cause a processor to execute operations, the operations including:
extracting, from a second image captured at a second time inside the vehicle, a partial image including a difference region in a difference image between a first image captured at a first time inside the vehicle and the second image;
acquiring a first output result regarding an item included in the second image by inputting, into a first trained model, the partial image and a first prompt inquiring as to an item included in the partial image; and
outputting a second output result regarding the correctness of the first output result by inputting, into a second trained model, the second image and a second prompt inquiring as to whether the item indicated by the first output result is included in the second image.

According to an embodiment of the present disclosure, it is possible to identify items in vehicles with higher accuracy.

### BRIEF DESCRIPTION OF THE DRAWINGS

In the accompanying drawings:

FIG. 1 is a diagram illustrating an example of a configuration of a monitoring system according to an embodiment;

FIG. 2 is a schematic diagram illustrating an example of a vehicle equipped with a terminal apparatus;

FIG. 3 is a block diagram illustrating an example of a configuration of the terminal apparatus in FIG. 1;

FIG. 4 is a block diagram illustrating an example of a configuration of a server apparatus in FIG. 1;

FIG. 5 is a flowchart illustrating an example of an operation procedure of the monitoring system;

FIG. 6 is a diagram illustrating an example of a first image; and

FIG. 7 is a diagram illustrating an example of a second image.

### DETAILED DESCRIPTION

An embodiment of the present disclosure will be described below, with reference to the drawings. In the drawings, portions having the same configuration or function are denoted by the same reference numeral. In the description of the present embodiment, duplicate descriptions of the same portions are in some cases omitted or simplified, as appropriate.

### Outline of Embodiment

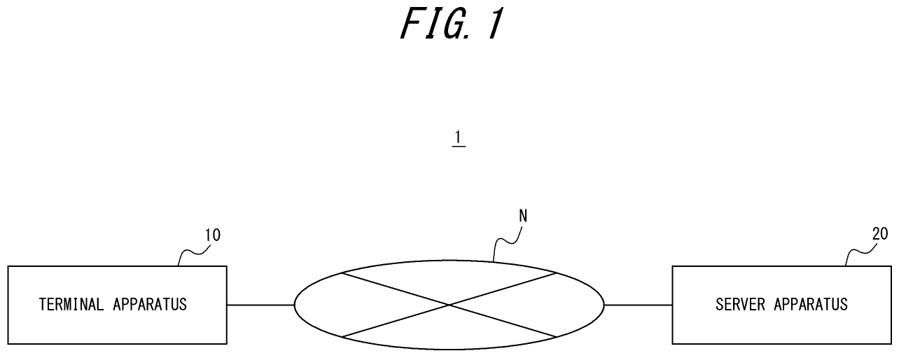

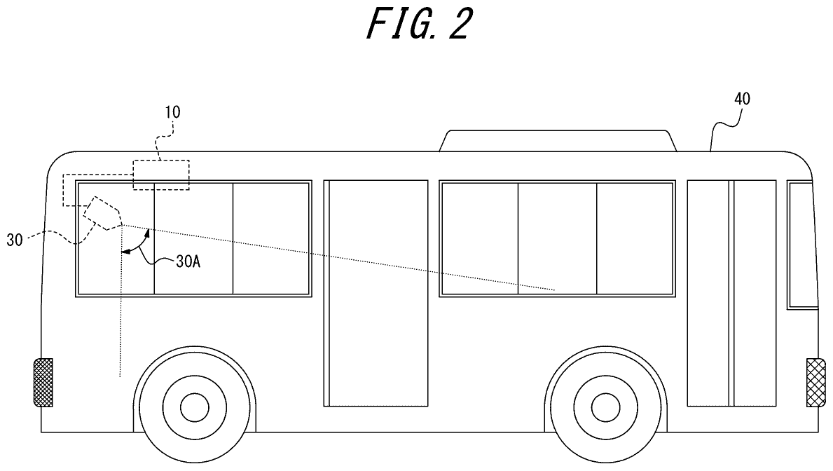

FIG. 1 is a diagram illustrating an example of a configuration of a monitoring system 1 according to the embodiment. The monitoring system 1 identifies an item such as a forgotten or lost item left in a vehicle 40 (see FIG. 2) based on images captured inside the vehicle 40.

The monitoring system 1 includes a terminal apparatus 10 and a server apparatus 20. The terminal apparatus 10 and the server apparatus 20 are communicably connected to each other via a network N. The network N may include, for example, the Internet, an intranet, a mobile communication network, and/or the like.

The terminal apparatus 10 is a computer that acquires images captured inside the vehicle 40 and identifies an item left in the vehicle 40 by analyzing the captured images. The terminal apparatus 10 is, for example, a general purpose computer such as a personal computer (PC) or a tablet terminal, but may also be configured as any dedicated electronic device. As will be described later with reference to FIG. 2, in the present embodiment, the terminal apparatus 10 is provided as an in-vehicle apparatus mounted in the vehicle 40. However, the terminal apparatus 10 is not limited to the in-vehicle apparatus. For example, the terminal apparatus 10 may acquire the images captured inside the vehicle 40 by receiving the captured images from another apparatus via the network N or reading the captured images from a recording medium such as a universal serial bus (USB) flash device.

The server apparatus 20 is a computer that manages information on items regarding forgotten items left in the vehicle 40, and verifies the analysis results of captured images by the terminal apparatus 10. The server apparatus is a general purpose computer such as a workstation (WS) or a PC, but may also be configured as any dedicated electronic device.

FIG. 2 is a schematic diagram illustrating an example of the vehicle 40 equipped with the terminal apparatus 10. As illustrated in FIG. 2, a camera 30 is provided in the vehicle 40 as an imager that captures a predetermined imaging range 30A to acquire captured images. The camera 30 is connected to the terminal apparatus 10, and transmits the captured images to the terminal apparatus 10.

In the present embodiment, the camera 30 may be a depth camera that acquires depth images. The depth images are images in which the distance from the camera 30 to each pixel of the images is expressed by, for example, brightness or the like. The depth camera may be constructed by existing technology for stereo cameras, Time of Flight (ToF) cameras, or structured light cameras, but the operating principle of the depth camera is arbitrary.

Hereinafter, an example in which the camera 30 is a depth camera that acquires depth images will be primarily described, but the type of camera 30 and the type of images acquired by the camera 30 are arbitrary. For example, the camera 30 may be an apparatus that acquires black-and-white or color two-dimensional images based on incident light.

The vehicle 40 is, for example, a bus, a microbus, a shared taxi, or the like that is boarded and alighted by unspecified persons, but the type and use of vehicle 40 are not limited to these. For example, the vehicle 40 may be an automobile owned by an individual, a rental car, or the like.

In such a configuration, the monitoring system 1 identifies a forgotten item from images captured by the camera 30, using a large language model (LLM) including a pre-trained visual language model (VLM). The visual language model is a generative model that generates text output in response to image and text input.

Specifically, a difference image, which indicates the difference between a first image captured at a first time and a second image captured at a second time inside the vehicle 40, is acquired. The difference image is calculated, for example, by obtaining the depth difference for each pixel between the first image and the second image. The first and second images are images obtained by capturing the same imaging range 30A by the camera 30. The first time may be, for example, a time before passengers board the vehicle 40. The second time may be, for example, a time after the passengers alight from the vehicle 40.

The monitoring system 1 inputs, into a first trained model, a partial image including a region with a significant difference with a certain extent recognized in the difference image and a first prompt inquiring as to an item included in the partial image, to acquire a first output result regarding the item included in the second image. The monitoring system 1 inputs, into a second trained model, the second image and a second prompt inquiring as to whether the item indicated by the first output result is included in the second image, to verify the correctness of the first output result. When the first output result is determined to be correct, the monitoring system 1 registers the item indicated by the first output result. The first and second prompts are text instructions for giving instructions or inquiries to the trained models.

Thus, the monitoring system 1 determines, based on the difference image, the region in which an item is assumed to be included, acquires the first output result for the partial image including that region using the first machine learning model, and further verifies the appropriateness of the first output result using the second machine learning model. The monitoring system 1 can detect items such as forgotten items with high accuracy by using the two pre-trained models.

### (Terminal Apparatus 10)

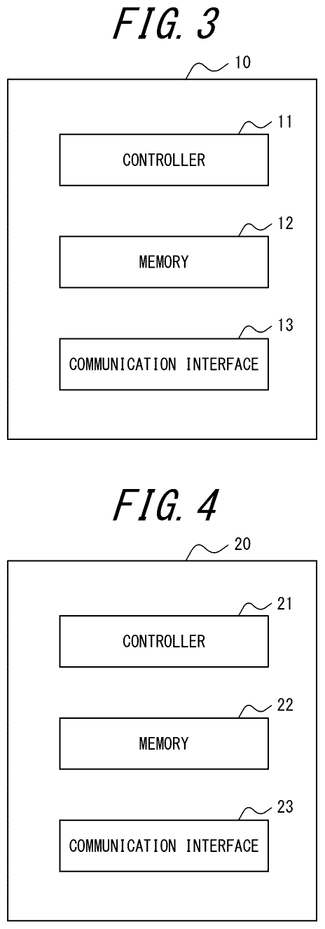

FIG. 3 is a block diagram illustrating an example of a configuration of the terminal apparatus 10 in FIG. 1. The terminal apparatus 10 includes a controller 11, a memory 12, and a communication interface 13.

The controller 11 includes at least one processor, at least one programmable circuit, at least one dedicated circuit, or a combination of these. The processor is, for example, a general purpose processor such as a central processing unit (CPU) or a graphics processing unit (GPU), or a dedicated processor that is specialized for specific processing, but is not limited to these. The programmable circuit is, for example, a field-programmable gate array (FPGA), but is not limited to this. The dedicated circuit is, for example, an application specific integrated circuit (ASIC), but is not limited to this. The controller 11 controls operations of the entire terminal apparatus 10.

The memory 12 includes one or more memories. The memories are, for example, semiconductor memories, magnetic memories, or optical memories, but are not limited to these. The memories included in the memory 12 may each function as, for example, a main memory, an auxiliary memory, or a cache memory. The memory 12 stores any information used for operations of the terminal apparatus 10. For example, the memory 12 may store a system program, an application program, embedded software, or the like. The information stored in the memory 12 may be updated with, for example, information acquired from the network N via the communication interface 13.

The communication interface 13 includes at least one communication interface for connecting to the network N. The communication interface is compliant with a mobile communication standard, a wired local area network (LAN) standard, or a wireless LAN standard, but is not limited to these and may be compliant with any communication standard. The mobile communication standard includes, for example, the 4th generation (4G) standard or the 5th generation (5G) standard, but is not limited to these. In the present embodiment, the terminal apparatus 10 communicates with the server apparatus 20 via the communication interface 13 and the network N.

The functions of the terminal apparatus 10 may be realized by executing a computer program (program) according to the present embodiment on a processor included in the controller 11. That is, the functions of the terminal apparatus 10 may be realized by software. The computer program causes a computer to execute the processes of steps included in operations of the terminal apparatus 10, thereby enabling the computer to realize functions corresponding to the processes of the steps. That is, the computer program is a program for causing the computer to function as the terminal apparatus 10 according to the present embodiment. The computer program may be recorded on a computer readable recording medium. The program encompasses information that is to be used for processing by an electronic computer and is thus equivalent to a program. For example, data that is not a direct command to a computer but has a property that regulates processing of the computer is “equivalent to a program” in this context.

The computer program can be recorded on a computer readable recording medium. The computer readable recording medium is, for example, a magnetic recording device, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may be distributed by storing the program in the storage of a server and transferring the program from the server to another computer via a network. The program may also be provided as a program product.

For example, the computer may temporarily store, in the main memory, the program recorded on the portable recording medium or the program transferred from the server. Then, the computer may read the program stored in the main memory using the processor, and execute processes in accordance with the read program using the processor. The computer may read the program directly from the portable recording medium, and execute processes in accordance with the program. The computer may, each time the program is transferred from the server to the computer, sequentially execute processes in accordance with the received program. Such processing may be executed by a so-called application service provider (ASP) type service that realizes functions merely by execution instructions and result acquisitions, without transferring the program from the server to the computer. The program encompasses information that is to be used for processing by an electronic computer and is thus equivalent to a program. For example, data that is not a direct command to a computer but has a property that regulates processing of the computer is “equivalent to a program” in this context.

Some or all of the functions of the terminal apparatus 10 may be realized by a dedicated circuit included in the controller 11. That is, some or all of the functions of the terminal apparatus 10 may be realized by hardware. The terminal apparatus 10 may be realized by a single computer or by the collaboration of multiple computers that can communicate with each other.

### (Server Apparatus 20)

FIG. 4 is a block diagram illustrating an example of a configuration of the server apparatus 20 in FIG. 1. The server apparatus 20 includes a controller 21, a memory 22, and a communication interface 23. The controller 21, the memory 22, and the communication interface 23 of the server apparatus 20 are similar to the controller 11, the memory 12, and the communication interface 13 of the terminal apparatus 10, so detailed explanations thereof are omitted. As with the terminal apparatus 10, the functions of the server apparatus 20 may be realized by software or by hardware. The server apparatus 20 may be realized by a single computer or by the collaboration of multiple computers that can communicate with each other.

### (Example of Operations)

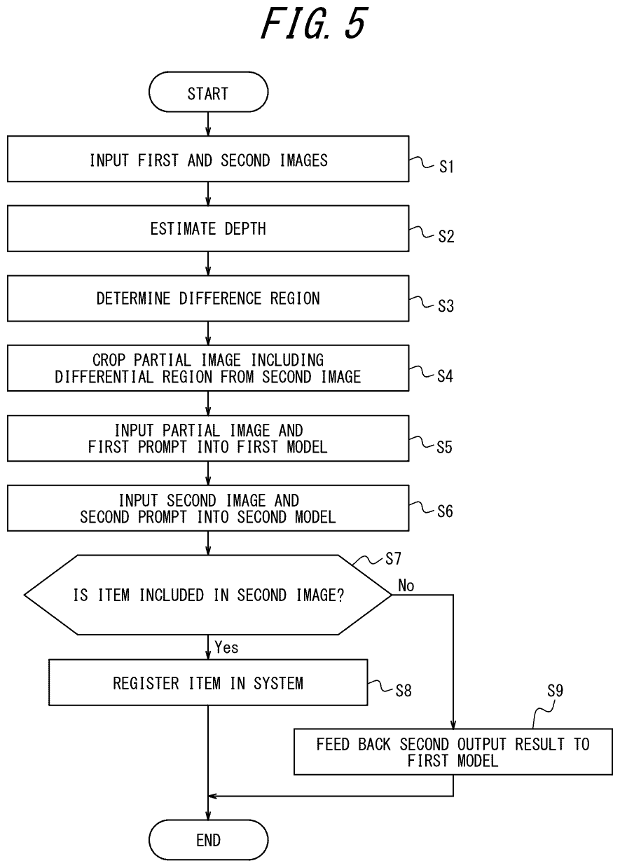

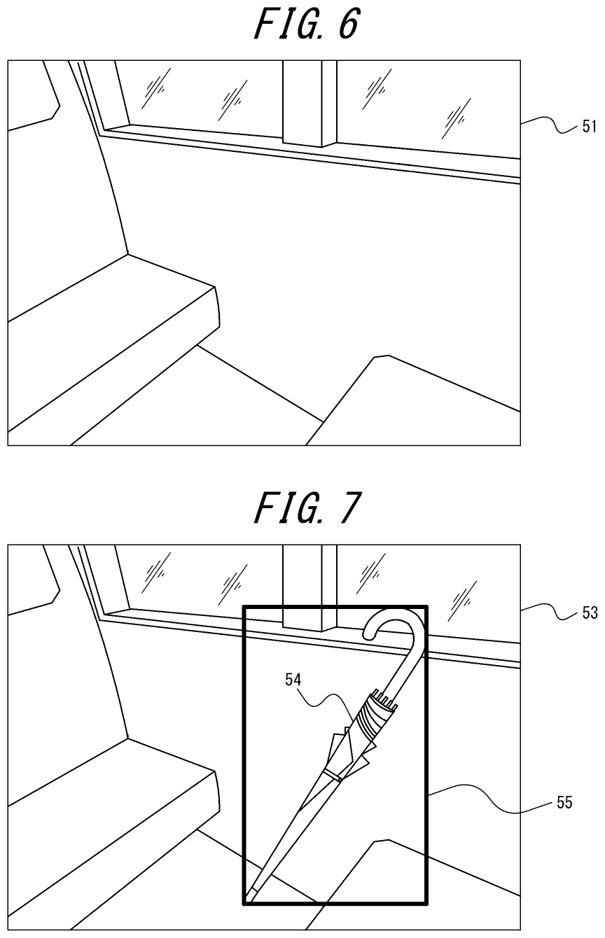

An example of operations of the monitoring system 1 as described above will be explained with reference to FIG. 5 to FIG. 7. FIG. 5 is a flowchart illustrating an example of an operation procedure of the monitoring system 1. FIG. 6 is a diagram illustrating an example of a first image. FIG. 7 is a diagram illustrating an example of a second image.

The operations of the monitoring system 1 to be explained with reference to FIG. 5 to FIG. 7 may correspond to one of monitoring methods of the monitoring system 1. The operation of each step from FIG. 5 to FIG. 7 may be executed based on the control by the controller 11 of the terminal apparatus or the controller 21 of the server apparatus 20.

Hereinafter, an example of operations in which the terminal apparatus acquires a first output result using a first machine learning model for a partial image of a second image, which includes a region assumed to include an item, and the server apparatus 20 verifies the appropriateness of the first output result using a second machine learning model will be described. The division of processes between the terminal apparatus 10 and the server apparatus 20 is not limited to this. For example, either the terminal apparatus or the server apparatus 20 may perform all the processes.

In S1, the controller 11 of the terminal apparatus 10 inputs a first image captured at a first time and a second image captured at a second time inside the vehicle 40. The first time may be, for example, a time before passengers board the vehicle 40. The second time may be, for example, a time after the passengers alight from the vehicle 40. The first and second images are acquired by capturing the same imaging range 30A by the camera 30.

FIG. 6 illustrates an example of a first image 51. FIG. 7 illustrates an example of a second image 53. FIG. 7 illustrates a situation in which an umbrella 54 is left as a forgotten item.

In S2, the controller 11 estimates depth from the first image 51 and the second image 53 acquired in S1. When the first image 51 and the second image 53 are depth images, each pixel of the first image 51 and the second image 53 indicates depth. When the first image 51 and the second image 53 are monochrome or color normal two-dimensional images, the controller 11 may estimate depth based on, for example, the brightness, saturation, and the like of the first image 51 and the second image 53. For example, the controller 11 may estimate depth with reference to a predetermined relationship between brightness, saturation, and depth.

In S3, the controller 11 calculates a difference image between the first image 51 and the second image 53, and determines a difference region from the second image 53. The difference region is a region in which a significant difference with a certain extent is recognized in the difference image.

Specifically, the controller 11 calculates, for each pixel of the first image 51 and the second image 53, the difference in pixel values (depth in the case of depth images) between the first image 51 and the second image 53, to acquire a difference image. Next, the controller 11 determines a region in which a significant difference with a certain extent is recognized in the difference image. For example, the controller 11 may determine, as difference pixels, pixels whose difference in pixel values between corresponding pixels in the first image 51 and the second image 53 is equal to or greater than a predetermined constant value. The controller 11 may determine, as a difference region, a region constituted of a set of difference pixels adjacent to each other that has an area equal to or greater than a predetermined threshold. In other words, even in a case in which multiple difference pixels are adjacent, the controller 11 may remove the multiple adjacent difference pixels as noise when the area of a region connecting the adjacent difference pixels is smaller than an area expected when an object is captured. The difference region determined as described above corresponds to a region occupied by an object (in the example of FIG. 7, the umbrella 54) in the second image 53.

In S4, the controller 11 crops, from the second image 53, a partial image including the difference region determined in S3. For example, the controller 11 may crop, from the second image 53, a rectangular partial image that circumscribes the difference region determined in S3. In FIG. 7, a region 55 is a rectangular region cropped based on the difference region corresponding to the region occupied by the umbrella 54. When there are multiple difference regions determined in S3, the controller 11 crops, for each of the multiple difference regions, a partial image including the difference region from the second image 53. The monitoring system 1 can enhance the detection accuracy of items by detecting items on a partial image basis.

In S5, the controller 11 inputs the partial image acquired in S4 and a first prompt inquiring as to an item included in the partial image into a first model, as a first trained model, to acquire a first output result regarding the item included in the second image. When inputting the partial image into the first model, the controller 11 may encode the partial image according to an encoding method corresponding to the specifications of the model. The controller 11 transmits the second image and the first output result to the server apparatus 20 via the communication interface 13 and the network N.

The first model is a large language model that includes a pre-trained visual language model. The visual language model is a machine learning model (multimodal model) trained by mapping the feature quantities of visual input and the feature quantities of language input into a single feature space. The first model is pre-trained with large-scale data related to images and documents so that, when at least an image and a first prompt are input, the first model outputs the item name of an item captured in the image. The first model may be pre-trained using existing techniques, for example, with large-scale data such as universal image-text representation learning (UNITER), common objects in context (COCO), Visual Genome, or the like.

The first prompt may be a text instruction in the form of, for example, “What is included in this image?” The first output result may be a text response in the form of, for example, “The image includes an umbrella.”

In S6, the controller 21 of the server apparatus 20 inputs the second image and a second prompt into a second model, as a second trained model, to verify the correctness of the first output result. When inputting the second image into the second model, the controller 21 may encode the second image according to an encoding method corresponding to the specifications of the model.

The second model is a large language model that includes a pre-trained visual language model. The second model is pre-trained with large-scale data related to images and documents so that, when at least an image and a second prompt including an item name are input, the second model outputs whether an item specified by the item name is captured in the image.

The second prompt is a text instruction that inquires whether the item indicated by the first output result is included in the second image. The second prompt may be a text instruction in the form of, for example, “Does this image include an umbrella?” The second output result may be a text response in the form of, for example, “Yes” or “No.”

In S7, the controller 21 proceeds to S8 when it is determined that the item indicated by the first output result is included in the second image based on the second output result obtained in S6 (Yes in S7), and proceeds to S9 otherwise (No in S7).

In S8, the controller 21 registers, in the system, the item that has been determined to be included in the second image, as a forgotten item. For example, the controller 21 may register the item name and the second image in a database constructed in the memory 12, in association with related information such as identification information on the vehicle 40, the date and time, and the location (e.g., GPS information.)

The controller 21 may input additional prompts into the second model to profile lost and forgotten items, and may also register the results together. For example, when the item included in the second image is an umbrella, the controller 21 may input a prompt such as “What color is this umbrella?” into the second model to output the color of the umbrella. Alternatively, for example, the controller 21 may input a prompt such as “What type of umbrella is this?” into the second model to output the type of umbrella (for example, folding umbrella, stick type, vinyl umbrella, sun umbrella, or the like.) Alternatively, for example, the controller 21 may input a prompt such as “Is this umbrella for children?” into the second model to output whether the umbrella is for children or adults. Alternatively, for example, the controller 21 may input a prompt such as “Where was this umbrella found?” into the second model to output the location in the vehicle 40 in which the umbrella was found (for example, near the door, on the back seat, in the aisle, or the like.) Alternatively, for example, the controller 21 may also inquire information such as the date and time and the location of the vehicle 40, by inputting prompts into the second model. The controller 21 may register these output results in the database in association with the item name.

After executing S8, the controller 21 ends the processes of the flowchart.

In S9, the controller 21 feeds back the second output result to the first model. Specifically, the controller 21 of the server apparatus 20 notifies the terminal apparatus 10 that the output obtained as the second output result indicates that the item indicated by the first output result is not included in the second image. Upon receiving the notification from the server apparatus 20, the controller 11 of the terminal apparatus 10 may re-train the first model to improve the false detection of the first model, or input a prompt indicating that the item indicated by the first output result is not included in the second image into the first model. After executing S9, the controller 21 ends the processes of the flowchart.

As described above, the monitoring system 1 monitors the interior of the vehicle 40 using the imager. Specifically, the monitoring system 1 extracts, from a second image captured at a second time inside the vehicle 40, a partial image including a difference region with a significant difference with a certain extent recognized in a difference image, which indicates the difference between a first image captured at a first time inside the vehicle and the second image. The monitoring system 1 inputs, into a first model, the partial image and a first prompt inquiring as to an item included in the partial image. The first model is a pre-trained model that is trained, when at least an image and a first prompt are input, to output the item name of an item captured in the image. The monitoring system 1 acquires a first output result regarding the item included in the second image, output from the first model. The monitoring system 1 inputs, into a second model, the second image and a second prompt inquiring as to whether the item indicated by the first output result is included in the second image. The second model is a pre-trained model that is trained, when at least an image and a second prompt including an item name are input, to output whether an item specified by the item name is captured in the image. The monitoring system 1 outputs a second output result regarding the correctness of the first output result, output from the second model.

As described above, the monitoring system 1 can improve the accuracy of item identification by providing the different prompts to the trained machine learning models.

The second model may be the same as the first model or a different model. Even when the first model and the second model are the same model, the first output result can be verified with high accuracy by using different prompts. For example, the first model used in the terminal apparatus 10 may be a lightweight model capable of high-speed processing. The second model used in the server apparatus 20 may be a model capable of producing high-accuracy output through more computationally intensive operations. As described above, using the trained models according to the resources of the terminal apparatus 10 and the server apparatus 20 makes it easier to implement the model in the terminal apparatus 10, thus reducing computational power required by the terminal apparatus 10 and reducing communication volume between the terminal apparatus 10 and the server apparatus 20. Moreover, by performing high-accuracy calculations in the more resource-rich server apparatus 20, it is possible to produce high-accuracy output. For example, upon detecting a forgotten item, the terminal apparatus may immediately notify the passengers of the vehicle 40 that there is a forgotten item.

The first image and the second image may be depth images that express distance from the camera 30 for each pixel of the images. The difference image may be an image indicating the difference in a depth direction between the first image and the second image. As described above, the monitoring system 1 can identify a forgotten item inside the vehicle 40 with high accuracy, by using depth images as the first and second images, regardless of the lighting conditions inside the vehicle 40 and the conditions of light incident from outside.

The monitoring system 1 identifies an item that is included in only one of the first and second images captured at different times, but its application is not limited to identifying a forgotten item. For example, when the second time is earlier than the first time, and an item included in the second image captured at the second time is not present in the first image captured at the first time, the monitoring system 1 may determine that the item has been stolen.

The monitoring system 1 outputs the second output result regarding the correctness of the first output result using the second model, but the second output result is not limited to a binary choice of “correct” or “incorrect.” For example, the monitoring system 1 may output a value indicating the degree of correctness of the first output result (for example, a value between 0 and 1) or one of several levels (for example, A, B, C, and the like) as the second output result.

The present disclosure is not limited to the embodiment described above. For example, a plurality of blocks described in the block diagram may be integrated, or a single block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these.
[Appendix 1] A monitoring system for monitoring an interior of a vehicle using an imager, the monitoring system configured to:
   extract, from a second image captured at a second time inside the vehicle, a partial image including a difference region with a significant difference with a certain extent recognized in a difference image indicating a difference between a first image captured at a first time inside the vehicle and the second image;
   acquire a first output result regarding an item included in the second image by inputting, into a first trained model, the partial image and a first prompt inquiring as to an item included in the partial image, the first trained model having been pre-trained, when at least an image and a first prompt are input, to output an item name of an item captured in the image; and
   output a second output result regarding correctness of the first output result by inputting, into a second trained model, the second image and a second prompt inquiring as to whether the item indicated by the first output result is included in the second image, the second trained model having been pre-trained, when at least an image and a second prompt including an item name are input, to output whether an item specified by the item name is captured in the image.
[Appendix 2] A monitoring system for monitoring an interior of a vehicle using an imager, the monitoring system configured to:
   extract, from a second image captured at a second time inside the vehicle, a partial image including a difference region in a difference image between a first image captured at a first time inside the vehicle and the second image;
   acquire a first output result regarding an item included in the second image by inputting, into a first trained model, the partial image and a first prompt inquiring as to an item included in the partial image; and
   output a second output result regarding correctness of the first output result by inputting, into a second trained model, the second image and a second prompt inquiring as to whether the item indicated by the first output result is included in the second image.
[Appendix 3] The monitoring system according to appendix 2, wherein the first trained model and the second trained model are same.
[Appendix 4] The monitoring system according to appendix 2 or 3, wherein the second trained model is a trained model that outputs a result with higher accuracy than the first trained model.
[Appendix 5] The monitoring system according to any one of appendices 2 to 4, comprising:
   a server apparatus; and
   a terminal apparatus mounted in the vehicle, the server apparatus and the terminal apparatus being configured to be communicable with each other,
   wherein
   the terminal apparatus is configured to execute a process to acquire the first output result regarding the item included in the second image by inputting, into the first trained model, the partial image and the first prompt inquiring as to the item included in the partial image, and
   the server apparatus is configured to execute a process to output the second output result regarding the correctness of the first output result by inputting, into the second trained model, the second image and the second prompt inquiring as to whether the item indicated by the first output result is included in the second image.
[Appendix 6] The monitoring system according to any one of appendices 2 to 5, configured to:
   determine, as difference pixels, pixels whose difference in pixel values between corresponding pixels in the first image and the second image is equal to or greater than a predetermined constant value;
   determine, as the difference region, a region constituted of a set of difference pixels adjacent to each other that has an area equal to or greater than a predetermined threshold; and
   extract, as the partial image from the second image, an image including the determined difference region.
[Appendix 7] The monitoring system according to any one of appendices 2 to 6, configured to register the item indicated by the first output result in a memory when the second output result indicates that the first output result is correct.
[Appendix 8] The monitoring system according to any one of appendices 2 to 7, wherein
   the first and second images are depth images that express distance from a camera for each pixel of the images, and
   the difference image is an image indicating difference in a depth direction between the first image and the second image.
[Appendix 9] A monitoring method performed by a monitoring system for monitoring an interior of a vehicle using an imager, the monitoring method comprising:
   extracting, from a second image captured at a second time inside the vehicle, a partial image including a difference region in a difference image between a first image captured at a first time inside the vehicle and the second image;
   acquiring a first output result regarding an item included in the second image by inputting, into a first trained model, the partial image and a first prompt inquiring as to an item included in the partial image; and
   outputting a second output result regarding correctness of the first output result by inputting, into a second trained model, the second image and a second prompt inquiring as to whether the item indicated by the first output result is included in the second image.
[Appendix 10] The monitoring method according to appendix 9, wherein the first trained model and the second trained model are same.
[Appendix 11] The monitoring method according to appendix 9 or 10, wherein the second trained model is a trained model that outputs a result with higher accuracy than the first trained model.
[Appendix 12] The monitoring method according to any one of appendices 9 to 11, wherein
   the monitoring system includes a server apparatus and a terminal apparatus mounted on the vehicle, the server apparatus and the terminal apparatus being configured to be communicable with each other,
   the terminal apparatus is configured to execute a process to acquire the first output result regarding the item included in the second image by inputting, into the first trained model, the partial image and the first prompt inquiring as to the item included in the partial image, and
   the server apparatus is configured to execute a process to output the second output result regarding the correctness of the first output result by inputting, into the second trained model, the second image and the second prompt inquiring as to whether the item indicated by the first output result is included in the second image.
[Appendix 13] The monitoring method according to any one of appendices 9 to 12, comprising:
   determining, as difference pixels, pixels whose difference in pixel values between corresponding pixels in the first image and the second image is equal to or greater than a predetermined constant value;
   determining, as the difference region, a region constituted of a set of difference pixels adjacent to each other that has an area equal to or greater than a predetermined threshold; and
   extracting, as the partial image from the second image, an image including the determined difference region.
[Appendix 14] The monitoring method according to any one of appendices 9 to 13, comprising registering the item indicated by the first output result in a memory when the second output result indicates that the first output result is correct.
[Appendix 15] A program for controlling a monitoring system for monitoring an interior of a vehicle, the program configured to cause a processor to execute operations, the operations comprising:
   extracting, from a second image captured at a second time inside the vehicle, a partial image including a difference region in a difference image between a first image captured at a first time inside the vehicle and the second image;
   acquiring a first output result regarding an item included in the second image by inputting, into a first trained model, the partial image and a first prompt inquiring as to an item included in the partial image; and
   outputting a second output result regarding correctness of the first output result by inputting, into a second trained model, the second image and a second prompt inquiring as to whether the item indicated by the first output result is included in the second image.
[Appendix 16] The program according to appendix 15, wherein the first trained model and the second trained model are same.
[Appendix 17] The program according to appendix 15 or 16, wherein the second trained model is a trained model that outputs a result with higher accuracy than the first trained model.
[Appendix 18] The program according to any one of appendices 15 to 17, wherein the operations comprise:
   determining, as difference pixels, pixels whose difference in pixel values between corresponding pixels in the first image and the second image is equal to or greater than a predetermined constant value;
   determining, as the difference region, a region constituted of a set of difference pixels adjacent to each other that has an area equal to or greater than a predetermined threshold; and
   extracting, as the partial image from the second image, an image including the determined difference region.
[Appendix 19] The program according to any one of appendices 15 to 18, wherein the operations comprise registering the item indicated by the first output result in a memory when the second output result indicates that the first output result is correct.
[Appendix 20] The program according to any one of appendices 15 to 19, wherein
   the first and second images are depth images that express distance from a camera for each pixel of the images, and
   the difference image is an image indicating difference in a depth direction between the first image and the second image.

1. A monitoring system for monitoring an interior of a vehicle using an imager, the monitoring system configured to:
extract, from a second image captured at a second time inside the vehicle, a partial image including a difference region with a significant difference with a certain extent recognized in a difference image indicating a difference between a first image captured at a first time inside the vehicle and the second image;
acquire a first output result regarding an item included in the second image by inputting, into a first trained model, the partial image and a first prompt inquiring as to an item included in the partial image, the first trained model having been pre-trained, when at least an image and a first prompt are input, to output an item name of an item captured in the image; and
output a second output result regarding correctness of the first output result by inputting, into a second trained model, the second image and a second prompt inquiring as to whether the item indicated by the first output result is included in the second image, the second trained model having been pre-trained, when at least an image and a second prompt including an item name are input, to output whether an item specified by the item name is captured in the image.

2. A monitoring system for monitoring an interior of a vehicle using an imager, the monitoring system configured to:
extract, from a second image captured at a second time inside the vehicle, a partial image including a difference region in a difference image between a first image captured at a first time inside the vehicle and the second image;
acquire a first output result regarding an item included in the second image by inputting, into a first trained model, the partial image and a first prompt inquiring as to an item included in the partial image; and
output a second output result regarding correctness of the first output result by inputting, into a second trained model, the second image and a second prompt inquiring as to whether the item indicated by the first output result is included in the second image.

3. The monitoring system according to claim 2, wherein the second trained model is a trained model that outputs a result with higher accuracy than the first trained model.

4. The monitoring system according to claim 2, wherein the first trained model and the second trained model are same.

5. The monitoring system according to claim 2, comprising:
a server apparatus; and
a terminal apparatus mounted in the vehicle, the server apparatus and the terminal apparatus being configured to be communicable with each other,
wherein
the terminal apparatus is configured to execute a process to acquire the first output result regarding the item included in the second image by inputting, into the first trained model, the partial image and the first prompt inquiring as to the item included in the partial image, and
the server apparatus is configured to execute a process to output the second output result regarding the correctness of the first output result by inputting, into the second trained model, the second image and the second prompt inquiring as to whether the item indicated by the first output result is included in the second image.

6. The monitoring system according to claim 2, configured to:
determine, as difference pixels, pixels whose difference in pixel values between corresponding pixels in the first image and the second image is equal to or greater than a predetermined constant value;
determine, as the difference region, a region constituted of a set of difference pixels adjacent to each other that has an area equal to or greater than a predetermined threshold; and
extract, as the partial image from the second image, an image including the determined difference region.

7. The monitoring system according to claim 2, configured to register the item indicated by the first output result in a memory when the second output result indicates that the first output result is correct.

8. The monitoring system according to claim 2, wherein
the first and second images are depth images that express distance from a camera for each pixel of the images, and
the difference image is an image indicating difference in a depth direction between the first image and the second image.

9. A monitoring method performed by a monitoring system for monitoring an interior of a vehicle using an imager, the monitoring method comprising:
extracting, from a second image captured at a second time inside the vehicle, a partial image including a difference region in a difference image between a first image captured at a first time inside the vehicle and the second image;
acquiring a first output result regarding an item included in the second image by inputting, into a first trained model, the partial image and a first prompt inquiring as to an item included in the partial image; and
outputting a second output result regarding correctness of the first output result by inputting, into a second trained model, the second image and a second prompt inquiring as to whether the item indicated by the first output result is included in the second image.

10. The monitoring method according to claim 9, wherein the second trained model is a trained model that outputs a result with higher accuracy than the first trained model.

11. The monitoring method according to claim 9, wherein the first trained model and the second trained model are same.

12. The monitoring method according to claim 9, wherein
the monitoring system includes a server apparatus and a terminal apparatus mounted on the vehicle, the server apparatus and the terminal apparatus being configured to be communicable with each other,
the terminal apparatus is configured to execute a process to acquire the first output result regarding the item included in the second image by inputting, into the first trained model, the partial image and the first prompt inquiring as to the item included in the partial image, and
the server apparatus is configured to execute a process to output the second output result regarding the correctness of the first output result by inputting, into the second trained model, the second image and the second prompt inquiring as to whether the item indicated by the first output result is included in the second image.

13. The monitoring method according to claim 9, comprising:
determining, as difference pixels, pixels whose difference in pixel values between corresponding pixels in the first image and the second image is equal to or greater than a predetermined constant value;
determining, as the difference region, a region constituted of a set of difference pixels adjacent to each other that has an area equal to or greater than a predetermined threshold; and
extracting, as the partial image from the second image, an image including the determined difference region.

14. The monitoring method according to claim 9, comprising registering the item indicated by the first output result in a memory when the second output result indicates that the first output result is correct.

15. A non-transitory computer readable medium storing a program for controlling a monitoring system for monitoring an interior of a vehicle, the program configured to cause a processor to execute operations, the operations comprising:
extracting, from a second image captured at a second time inside the vehicle, a partial image including a difference region in a difference image between a first image captured at a first time inside the vehicle and the second image;
acquiring a first output result regarding an item included in the second image by inputting, into a first trained model, the partial image and a first prompt inquiring as to an item included in the partial image; and
outputting a second output result regarding correctness of the first output result by inputting, into a second trained model, the second image and a second prompt inquiring as to whether the item indicated by the first output result is included in the second image.

16. The non-transitory computer readable medium according to claim 15, wherein the second trained model is a trained model that outputs a result with higher accuracy than the first trained model.

17. The non-transitory computer readable medium according to claim 15, wherein the first trained model and the second trained model are same.

18. The non-transitory computer readable medium according to claim 15, wherein the operations comprise:
determining, as difference pixels, pixels whose difference in pixel values between corresponding pixels in the first image and the second image is equal to or greater than a predetermined constant value;
determining, as the difference region, a region constituted of a set of difference pixels adjacent to each other that has an area equal to or greater than a predetermined threshold; and
extracting, as the partial image from the second image, an image including the determined difference region.

19. The non-transitory computer readable medium according to claim 15, wherein the operations comprise registering the item indicated by the first output result in a memory when the second output result indicates that the first output result is correct.

20. The non-transitory computer readable medium according to claim 15, wherein
the first and second images are depth images that express distance from a camera for each pixel of the images, and
the difference image is an image indicating difference in a depth direction between the first image and the second image.
